(19) United States
(12) Patent Application Publication
(10) Pub. No.: US 2008/0270248 A1
(43) Pub. Date: Oct. 30, 2008

(54) SYSTEM AND DEVICE FOR SOCIAL SHOPPING ON-LINE

(75) Inventor: Eric D. Brill, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/739,745

(22) Filed: Apr. 25, 2007

(51) Int. Cl. G06Q 30/00

(52) U.S. Cl. 705/26

(57) ABSTRACT

The claimed subject matter provides a system and/or method that constructs a real time interactive online social shopping network. The disclosed system can include a component that receives and transmits data from a client device and a merchant device, wherein the component employs the received and transmitted data to persist and associate information related to a user of the client device for display on the merchant device and utilizes the received and transmitted data to persist and associate information related to a retailer utilizing the merchant device for display on the client device.

### BACKGROUND

Advancements in networking and computing technologies have transformed many aspects of everyday life and in particular have transformed computers from being low performance/high cost devices capable of performing elementary word processing and simplistic/basic mathematical computations and manipulations to high-performance/low-cost machines capable of a myriad of disparate and highly complex functions and utilities. For instance, computers have become household staples rather than luxuries, educational tools, and/or entertainment centers, and can provide individuals and corporations tools to manage and forecast finances, control operations such as heating, cooling, lighting and security, and store records, and images in a permanent and reliable medium. As further illustration, at the consumer level computing devices can be employed to aid users in paying bills, tracking expenses, communicating nearly instantaneously with friends and/or family across vast distances by way of e-mail and/or instant messaging, obtaining information from networked the repositories, and numerous other functions/activities.

As computing and network technologies have evolved and have become more robust, secure and reliable, more consumers, wholesalers, retailers, entrepreneurs, educational institutions, and the like have and are shifting business paradigms and are employing the Internet to perform business rather than utilizing traditional means. For example, today consumers can access their bank accounts on-line (e.g., via the Internet) and can perform an ever growing number of banking transactions such as balance inquiries, fund transfers, bill payments, and the like.

The Internet provides unprecedented opportunity for the sale and advertising to an ever-increasing number of potential customers ranging from businesses to individuals. Money expended in online sales in the United States alone, is in the billions of dollars per year, and continues to increase with no end in sight. Accordingly, merchants (as well as non-merchants) are employing online advertising and sales techniques as a means of attracting an ever-increasing number of potential customers ranging from businesses to individuals.

The Internet in particular has provided users with a mechanism for obtaining information regarding any suitable subject matter. For example, various websites are dedicated to posting text, images, and video related to world, national, and/or local news. A user with knowledge of the Uniform Resource Locator (URL) associated with one of such websites can simply enter the URL into a web browser to be provided with the website and access content thereon. Another conventional manner of locating desired information from the Internet is through utilization of search engines. For instance, a user can enter a word or a series of words into a search field and thereafter initiate the search engine (e.g., through depression of a button, or one or more keystrokes, voice commands, . . . ). The search engine then utilizes search algorithms to locate websites or files related to the word or series of words entered by the user into the search field, and the user can then select one of websites returned by the search engine to review content therein.

As more and more people have begun to utilize Internet, it has become apparent that revenue opportunities abound for small and large businesses alike. For instance, many retail companies utilize the Internet to sell goods online, thereby reducing costs associated with managing and maintaining a store location, providing an ability to centralize inventory, and various other similar benefits that result in decreased costs that can be passed on to consumers. Given this increased use of the Internet for generating business and/or revenue, it has become apparent that the Internet can be utilized both as an effective advertising and/or sales mechanism/medium. In one example, an individual who enters the term “flower” into a search engine may be interested in purchasing flowers—thus, it can be beneficial for a company that sells flowers to advertise to that user at the point in time that the user is searching for the aforementioned term. Typically users will see the advertisements and click on such advertisements to purchase flowers, thereby creating business for the flower retailer. Furthermore, the search engine can be provided with additional revenue by selling advertisement space for a particular period of time to the flower retailer when the term “flower” is utilized as a search term. In a similar example, a sporting goods company may wish to display advertisements on a website related to sports, and can purchase advertising space for limited amount of time on the website. Again, the buying and selling of advertising space can lead to increased revenue for the owner of the website as well as the advertiser.

While online shopping can be extremely effective and efficient, currently there are no facilities to incorporate the social aspect customers can obtain at brick and mortar stores. Rather, the typical online shopping experience can be an extremely utilitarian, antiseptic encounter devoid of social interaction. More particularly, the typical online shopping experience fails to provide the full gamut of social experience (e.g., ambiance and/or human interaction, etc.) that can usually be encountered when visiting brick and mortar stores.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with one illustrative aspect relates to systems and methods that can establish and construct real time interactive online social shopping networks that can include, for example, components that receive and transmit data from client devices and merchant devices such that the received and transmitted data is utilized to permit the users of the system to carry on real-time interactive sessions to in order to capture the ambiance, immediacy, and feel of physical brick and mortar stores.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented online social shopping system in accordance with the claimed subject matter.

FIG. 2 provides a more detailed illustration of a portal component in accordance with one aspect of the claimed subject matter.

FIG. 3 illustrates a more detailed depiction of an exchange component in accordance with an aspect of the claimed subject mater.

FIG. 4 depicts an aspect of a machine implemented online social shopping system in accordance with an aspect of the claimed subject matter.

FIG. 5 illustrates a system implemented on a machine that can employ intelligence to establish an online social shopping session in accordance with an aspect of the claimed subject matter.

FIG. 6 depicts a merchant device in accordance with an aspect of the subject matter as claimed.

FIG. 7 illustrates a consumer device in accordance with an aspect of the subject matter as clamed.

FIG. 8 depicts an illustrative session between a merchant and a consumer in accordance with an aspect of the claimed subject matter.

FIG. 9 illustrates a further illustrative session between a merchant and a customer in accordance of yet another aspect of the claimed subject matter.

FIG. 10 depicts yet another illustrative session between a merchant and a customer in accordance with an aspect of the subject matter as claimed.

FIG. 11 illustrates a flow diagram of a machine implemented methodology that facilitates and effectuates an online shopping network in accordance with an aspect of the claimed subject matter.

FIG. 12 illustrates a block diagram of a computer operable to execute the disclosed online social shopping architecture.

FIG. 13 illustrates a schematic block diagram of an exemplary computing environment for processing the online social shopping architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

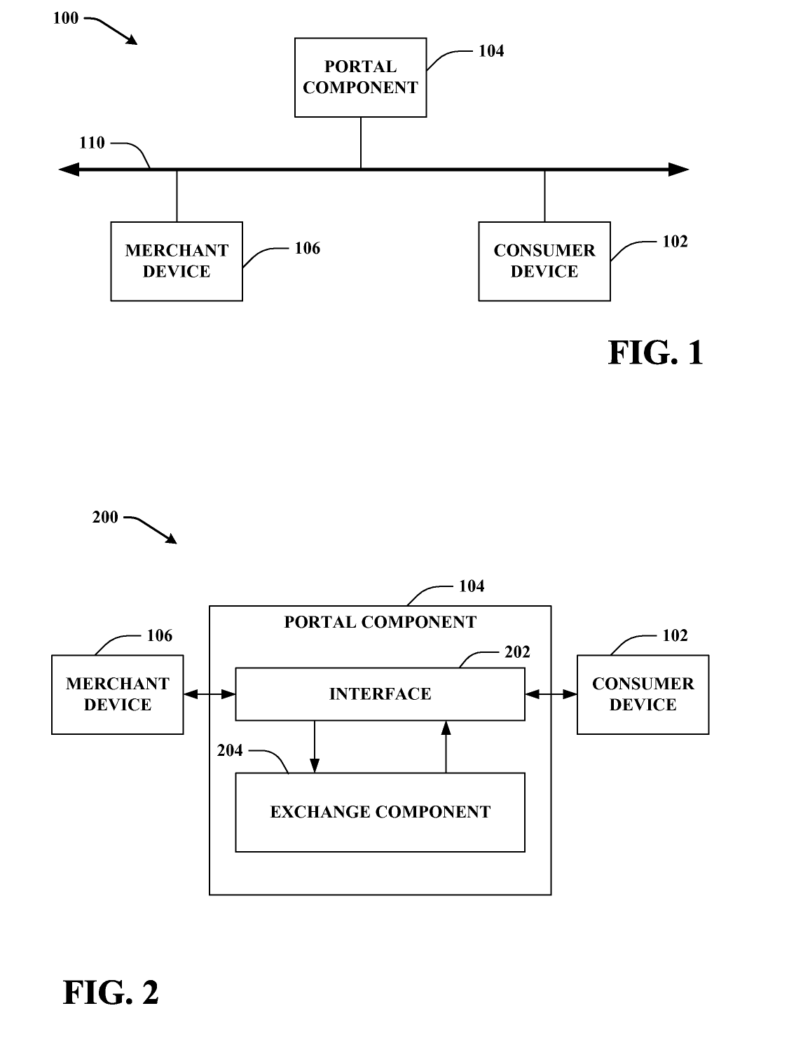

FIG. 1 illustrates an online social shopping system 100 that can include consumer device 102, merchant device 104, and portal component 106 that can be in wired and/or wireless communication with one another. As depicted, consumer device 102, merchant device 104, and portal component 106 can be situated on the multitude of disparate network topologies 110 (e.g., Local Area Networks (LANs), Wide Area Networks (WANs), Extranets, Intranets, the Internet, etc.). Moreover, consumer device 102 and merchant device 106 can be any computing device including, but not limited to, personal computers, Smart phones, cell phones, industrial automated devices, consumer devices, laptop computers, notebook computers, Tablet PCs, Personal Digital Assistants (PDAs), and/or any handheld device that includes a processor, and/or that can include a processor. Additionally and/or alternatively, consumer device 102 and merchant device 106 can include any device capable of facilitating and/or effectuating wired and/or wireless communication with portal component 104.

Portal component 104 can receive data from both consumer device 102 and merchant device 106 and based at least in part on the data received establish an online social shopping session between customers/clients utilizing consumer device 102 and merchants/retailers (e.g., sales clerks, proprietors of shopping emporiums, and the like) employing merchant device 106. Once an online social shopping session has been established between customers/clients and merchants/retailers, the merchant/retailer can, at the instigation of customers/clients, for example, contemporaneously display and/or demonstrate products and/or items of interest to the customer/client. Additionally and/or alternatively, customers/clients can make concurrent selections of items of interest that more closely represent or suit their needs, desires, and/or designs. For instance, where a customer/client is shopping for a piece of jewelry, the customer/client can initially make selections via consumer device 102 from the merchant/retailers current stock of items on display that vaguely approximate to his/her desired item of interest. Having narrowed down the scope of the search, the customer/client can concomitantly request information from the merchant/retailer regarding alternative items that many more closely match the desired item. The merchant/retailer via merchant device 106 can, if no stock items exactly correspond to the customer/clients criteria, and based at least in part on customer/client previous selections, the merchant/retailer's common knowledge of currently marketed products, and currently available and inventoried items, provide suggestions and/or alternatives of items that can better correspond to the customer/client's criteria. In this manner system 100, and more particularly, portal component 104 can provide an individuated online interactive exchange/marketplace that allows the merchant/retailer and the customer/client to facilitate an online shopping transaction that includes social interaction between merchant and customer to a successful and hopefully fruitful conclusion.

FIG. 2 provides a more detailed illustration 200 of portal component 104 in accordance with an aspect of the claimed subject matter. As depicted portal component 104 can comprise interface component 202 (hereinafter referred to as “interface 202”) that can receive data from multitude of sources, such as, for example, data associated with a particular good, item for sale and/or barter, service, user, client, merchant, customer, retailer, and/or entity involved with a portion of an online transaction, and thereafter convey received information to exchange component 204 for further analysis and/or to establish an online social shopping session. As illustrated, interface 202 included with portal component 104 can facilitate and effectuate electronic data interchange (e.g., receive and/or transmit) between consumer device 102 and merchant device 106 respectively.

Interface 202 can provide various adapters, connectors, channels, communication pathways, etc. to integrate the various components included in system 200 into virtually any operating system and/or database system and/or with one another. Additionally, interface 202 can provide various adapters, connectors, channels, communication modalities, etc., that can provide for interaction with various components that can comprise system 200, and/or any other component (external and/or internal), data and the like associated with system 200.

Exchange component 204 can, in a further aspect of the claimed subject matter, provide facilities to establish an online social forum between merchant/retailers employing merchant device 106 and consumer/customers utilizing consumer device 102. For instance, exchange component 204 can, based at least in part on information received from merchant/retailers (e.g., employing merchant device 106) and/or consumer/customers (e.g., utilizing consumer device 102) via interface 202 can determine the relative geographical locations (e.g., via Global Positioning Satellite (GPS), Internet Protocol (IP) address, and the like) of the merchant/retailer with respect to the consumer/customer, and can undertake appropriate and sufficient security activities to authenticate and permit customers/consumers and/or merchant/retailers to utilize the online shopping system in general, and in particular, to establish an online shopping session between the merchant and customer.

Exchange component 204 can in one aspect of the claimed subject matter provide a rating facility that can rate respective merchants/retailers and/or consumers/customers. Such rating can be based on previous transactions that can have taken place between respective merchants/retailers and customers/consumers. Additionally and/or alternatively, rating may be based on transactions that may have taken place between the customer/consumers and/or other vendors/merchants that utilize portal component 104 to conduct and establish online shopping transactions with various disparate consumers/customers. Further, rating of merchants/retailers and/or customers/consumers can be based on detected geographical location together with other previously gleaned and/or persistent information (e.g., merchants and/or customers can specify that they only wish to conduct transactions with parties that are located in a particular geographical location (e.g., country, state, city, zip/postal code, . . . )). Furthermore, exchange component 204 can determine ratings based on security attributes that can have been previously determined and/or persisted and/or that have been recently solicited, demographic information, social network analysis, previously established trust relationships, how much that a particular customer has spent in the past, and the like.

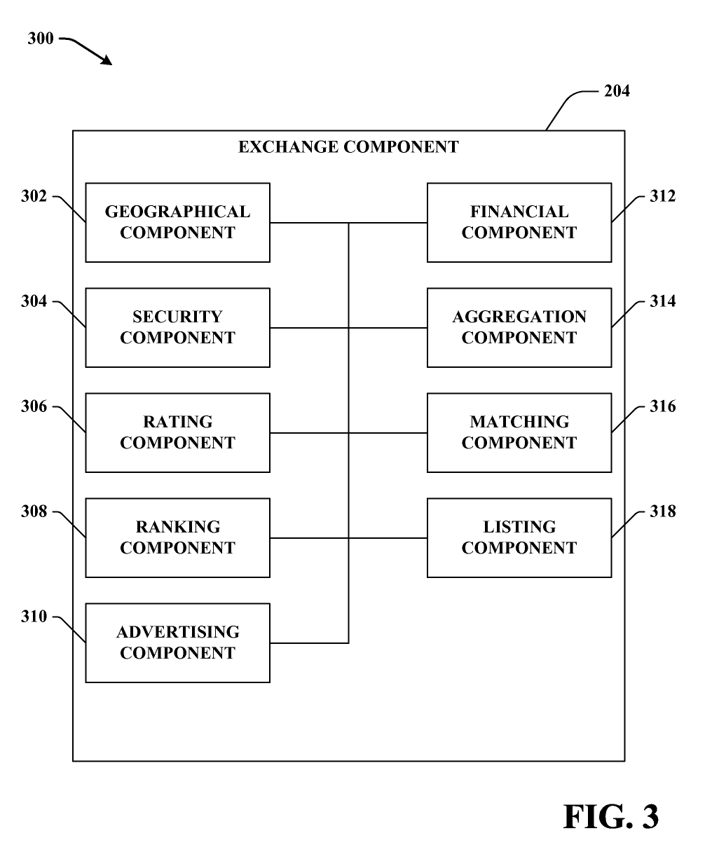

FIG. 3 provides further illustration 300 of exchange component 204 in accordance with an aspect of the claimed subject mater. Exchange component 204 can include a geographical component 302 that can ascertain the respective geographical location (e.g., through utilization of Global Positioning Satellite (GPS), Internet Protocol (IP) address, . . . ) of merchant/retailers and/or consumer/customers. Such geographic location information can, for example, be employed by exchange component 204 to determine the appropriateness and viability of suggesting and/or establishing an online social shopping transaction between the merchant/retailers and consumer/customers. Exchange component 204 can also include security component 304 that can employ one or more authentication and verification techniques to provide merchants/retailers and/or consumer/customers with access to the online social shopping system. Authentication and/or security methodologies and techniques that can be employed by security component 304 can include utilization of Access Control Lists (ACLs), password files, biometric access modalities, one or more cryptographic techniques, and the like.

Exchange component 204 can further include rating component 306 that can rate merchants/retailers and customer/consumers based, for example, on previous transactions that can have taken place between the merchant/retailer and the customer/consumer. Further, rating component 306 can utilize the magnitude of the transactions (e.g., monetary value of previous transaction and/or frequency of transaction that have taken place between the parties) to ascertain an appropriate rating to associate with a particular consumer/customer and merchant/retailer. Other factors that can be employed by rating component 306 can include transactions (e.g., frequency and monetary values of previous transaction) that can have taken placed between a particular client and disparate merchants/retailer associated the online social shopping system, geographical location of respective merchants/retailers and consumer/customers, etc.

Exchange component 204 can also include a ranking component 308 that can provide a relative ranking of merchants/retailers and/or customers/consumers based on contemporaneously determined and/or previously persisted geographical information, security profiles, rating data, etc. in order to allow a merchant/retailer or a consumer/customer to ascertain whether or not he/she wishes to establish an online social shopping transaction. Additionally and/or alternatively, exchange component 204 can include an advertising component 310 that allows various advertisements (e.g., prospective product demonstrations that can be scheduled by a particular vendor and/or merchant, sales that are currently taking place in the online social shopping portal, etc.) to be displayed to merchants/retailers and/or consumer/customers once they have been authenticated to exchange component 204. Further, exchange component 204 can also include financial component 312 that can undertake responsibility for all the financial transactions (e.g., credit card payments, billing, generating receipts and acknowledgements, and the like) that can take place between members of the online shopping portal (e.g., merchants/retailers and/or consumers/customers).

In addition, exchange component 204 can include an aggregation component 314 that can periodically and dynamically associate geographically diverse and/or disparate online social shopping portals (e.g., portals situated in Japan, China, South Africa, Canada, etc.) to create a “global” online shopping portal. Moreover, aggregation component 314 can fractionate individual online shopping portals and/or the aggregated “global” online shopping portal based on factors such as, for example, types of merchant/retailers (e.g., women's fashion retailers, lumber merchants, coffee shops, bookstores, electronic retailer, and the like), and/or overall monetary value of goods supplied by merchant/retailer associated with a particular online social shopping portal.

Exchange component 204 can also include matching component 316 that can facilitate matching merchants/retailers with appropriate customer/consumers, and visa versa, based at least on criteria (e.g., geographical location, rating, amount of money that a customer/consumer has previously spent while utilizing the online shopping portal, age of the consumer/customer, etc.) that can have been previously established and persisted and/or dynamically and contemporaneously solicited from the respective merchants/retailers and/or customer/consumers. Exchange component 204 can further include a listing component 318 that can provide a listing of all merchant/retailers associated with a particular online social shopping portal and/or “global” online social shopping portal. Additionally and/or alternatively, listing component 318 can provide listing based on geographical location, one or more determined rating and/or ranking, types of merchant/retailer, etc.

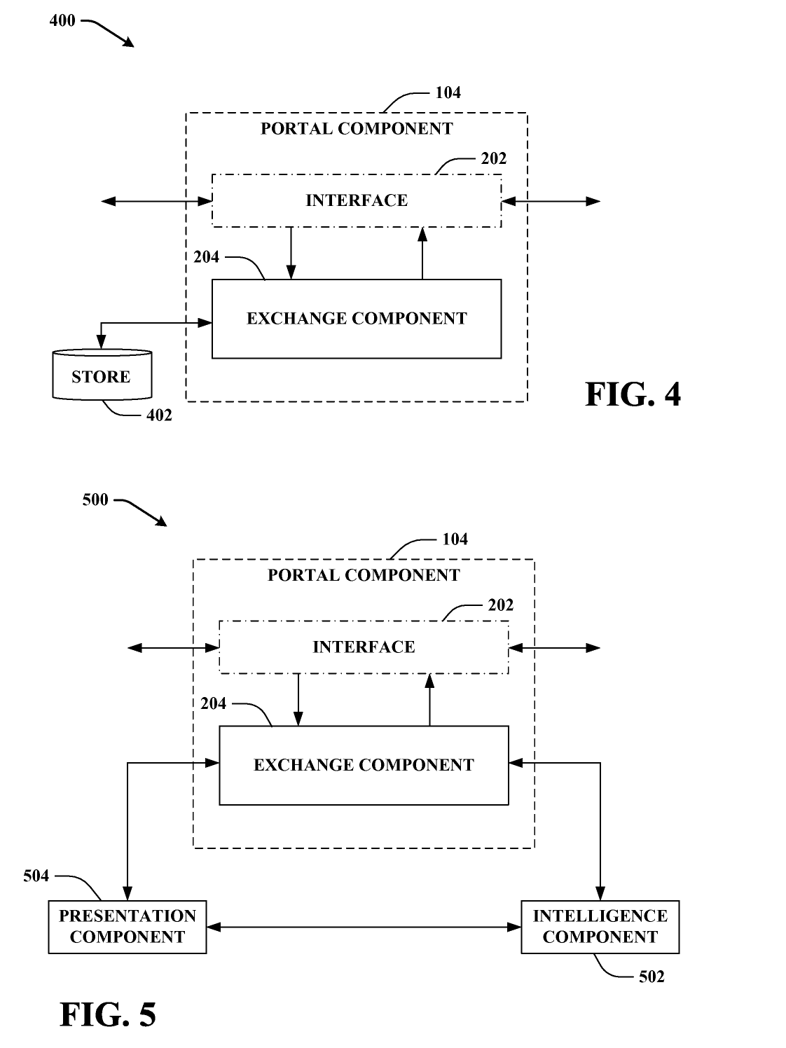

FIG. 4 depicts an aspect of an online social shopping system 400 that can include portal component 104 that can comprise interface 202 and exchange component 204. Additionally, system 400 can include store 402 that can include any suitable data necessary for exchange component 204 to effectuate and establish an online social shopping marketplace. For instance, store 402 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate network, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information gleaned from the disparate network, ratings from a website, a credit score, geographical location, a donation to charity, or any other information related to commerce, and/or any suitable data related to transactions, etc.

It is to be appreciated that store 402 can be, for example, by the volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM) and Rambus dynamic RAM (RDRAM). Store 402 of the subject systems and methods is intended to comprise, without being limited to, these and any other suitable types of memory. In addition, it is to be appreciated that store 402 can be a server, a database, a hard drive, and the like.

FIG. 5 illustrates a system 500 that can employ intelligence to establish an online social shopping session. System 500 can include portal component 104 that can further comprise interface 202 and exchange component 204 that provides facilities to establish online social forums between merchant/retailers employing a merchant device and/or consumer/customers utilizing a consumer device. System 500 further includes intelligence component 502. Intelligence component 502 can be utilized, for example, by exchange component 204 to provide suggestions to consumers/customers regarding appropriate merchants/retailers that might be able to satisfy the consumers/customers criteria.

It is to be understood that intelligence component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn) to a confidence that the input belongs to a class, that is, f(x)=confidence(class). Such classification can employ a probabilistic and/or statistical-based analysis (e.g., factoring into the analysis utilities and costs) to infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian Networks, decision trees, neural networks, fuzzy logic models, and probabilistic classification models providing different patterns of independence can be employed. Classification as used herein also is inclusive of statistical regression that is utilized to develop models of priority.

Exchange component 204 can further employ a presentation component 504 that can provide various types of user interface to facilitate interaction between merchants/retailers and/or consumer/customers and any component coupled to exchange component 204. As depicted, presentation component 504 is a separate entity that can be utilized with exchange component 204. However, it is to be appreciated that presentation component 504 and/or other similar view components can be incorporated into exchange component 204 and/or a standalone unit. Presentation component 504 can provide one or more graphical user interface, command line interface, and the like. For example, a graphical user interface can be rendered that provides a user with a region or means to load, import, read, etc., data, and can include a region to present the results of such. These regions can comprise known text and/or graphic regions comprising dialog boxes, static controls, drop down menus, list boxes, popup menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into exchange component 204.

The user can also interact with the regions to select and provide information via various devices such as a mouse, roller ball, keypad, keyboard, pen and/or voice activation, for example. Typically, the mechanism such as a push button or the enter key on the keyboard can be employed subsequent entering the information in order to initiate the search. However, it is to be appreciated that the claimed subject matter is not so limited. For example, nearly highlighting a check box can initiate information conveyance. In another example, a command line interface can be employed. For example, the command line interface can prompt (e.g., via a text message on a display and an audio tone) the user for information via providing a text message. The user can then provide suitable information, such as alphanumeric input corresponding to an option provided in the interface prompt or an answer to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black and white, and EGA) with limited graphic support, and/or low bandwidth communication channels.

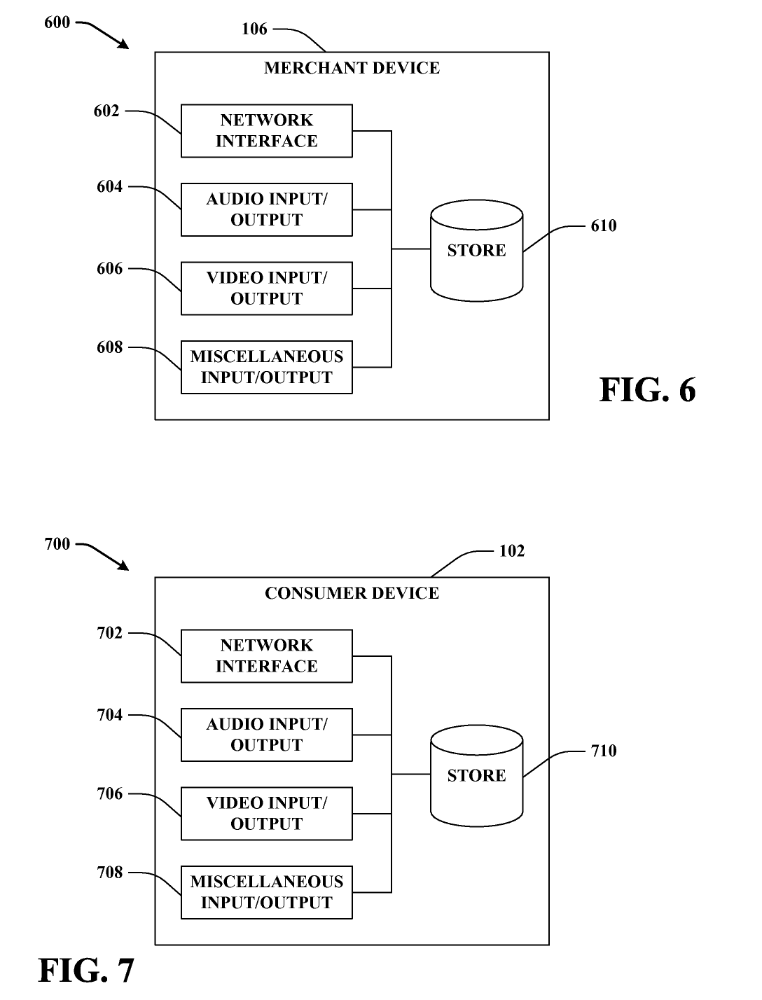

FIG. 6 illustrates 600 an illustrative merchant device 106 that can be utilized in conjunction with illustrative portal component 104 in accordance with one aspect of the claimed subject matter. Merchant device 106 can be any computing device including, but not limited to, Smart phones, Personal Digital Assistants (PDAs), laptop computers, notebook computers, cell phones, industrial and consumer electronic equipment, and/or any device that includes a processor, and/or that can include a processor. Merchant device 106 can include network device 602 that can facilitate and effectuate wired and/or wireless communications with one or more counterpart devices (e.g., consumer device 102, portal component 104, etc.). Merchant device 106 can also include audio input/output component 604 that can play and/or accept audio input/output. Merchant device 106 can also include video input/output component 606 that provide merchant device the ability to receive video input and to transmit video output to associated counterpart devices. Further, merchant device 106 can also include miscellaneous input/output devices 608 that can include keyboards, printers, pointing devices, credit card input facilities, etc. Further, merchant device 106 can include store 610 that can persist images and audio clips for future or contemporaneous use.

FIG. 7 illustrates 700 an illustrative consumer device 102 that can be used in concert with illustrative portal component 104 in accordance with an aspect of the claimed subject matter. Like merchant device 106 supra, consumer device 102 can be any computing device including, but not limited to, Smart phones, Personal Digital Assistants (PDAs), laptop computers, notebook computers, cell phones, industrial and consumer electronic equipment, and/or any device that includes a processor, and/or that can include a processor. Consumer device 102 can include network device 702 that can facilitate and effectuate wired and/or wireless communications one or more counterpart devices. Consumer device 102 to also include audio input/output component 704 that can record and/or accept audio input/output. Consumer device 102 can further include in one aspect of the claimed subject matter, video input/output that can provide consumer device the ability to display and record video images and static pictures. Additionally, consumer device 102 can include miscellaneous input/output components 708 that can include keyboards, printers, pointing devices and the like. Moreover consumer device 102 can also include a store for persisting various data received from counterpart devices, such as, for example, merchant device 106 and portal component 104.

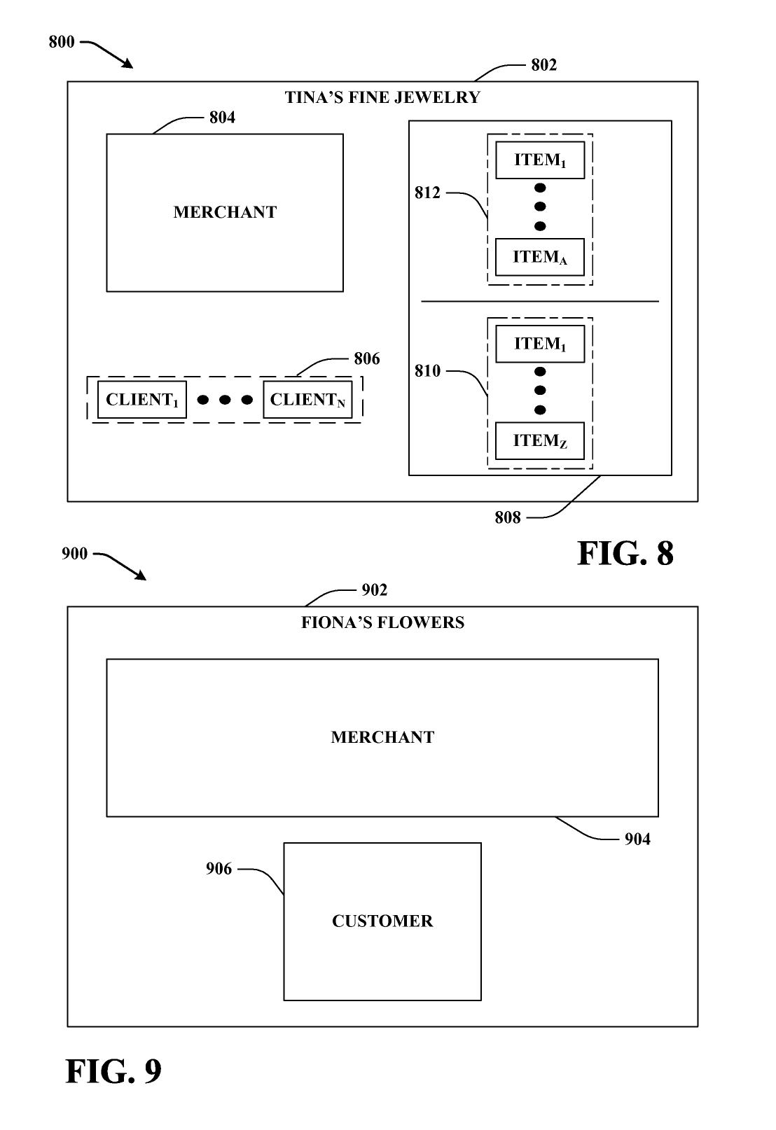

FIG. 8 provides illustration 800 of a session between a merchant and consumers in accordance with an aspect of the claimed subject matter. FIG. 8 depicts an illustrative display page 802 that can be displayed on merchant device 106 and consumer device 102 by portal component 104. Display page 802 can include resource information suitable for the World Wide Web, for instance, and can further be accessed through a software application that enables users to display and interact with text, images, and other information, such as, hyperlinks to other display pages. Display page 802 entitled “Tina's Fine Jewelry” can include frame 804 that can display an image (e.g., video or picture) of a merchant to client₁ to client_{N} 806, where N is a positive integer. Display page 802 can further include frame 808 that can be partitioned into subframe 810 and subframe 812. Subframe 810 can display items that client₁ to client_{N} 806 has selected as being of interest to him or her. Subframe 812 can display items that the merchant believes are similar to those items displayed in subframe 810 and that will be of more than a passing interest to client₁ to client_{N} 806.

FIG. 9 provides a further illustration 900 of a session between a merchant and consumer in accordance with a further aspect of the claimed subject matter. FIG. 9 depicts an illustrative display page 902 that can be simultaneously displayed on both merchant device 106 and consumer device 102 by portal component 104. The display page 902 entitled “Fiona's Flowers” can include frames 904 and 906 which can display a video 904 of the proprietor of the “Fiona's Flowers” website making up a flower bouquet for a customer whose image (e.g., video, or static image) and/or text (e.g., from a real-time communication based on typed text) can be displayed in frame 906. In this manner the customer can convey to the proprietor his or her personal likes and dislikes with regard the flower arrangement and can watch the proprietor make up the bouquet according to his or her direction.

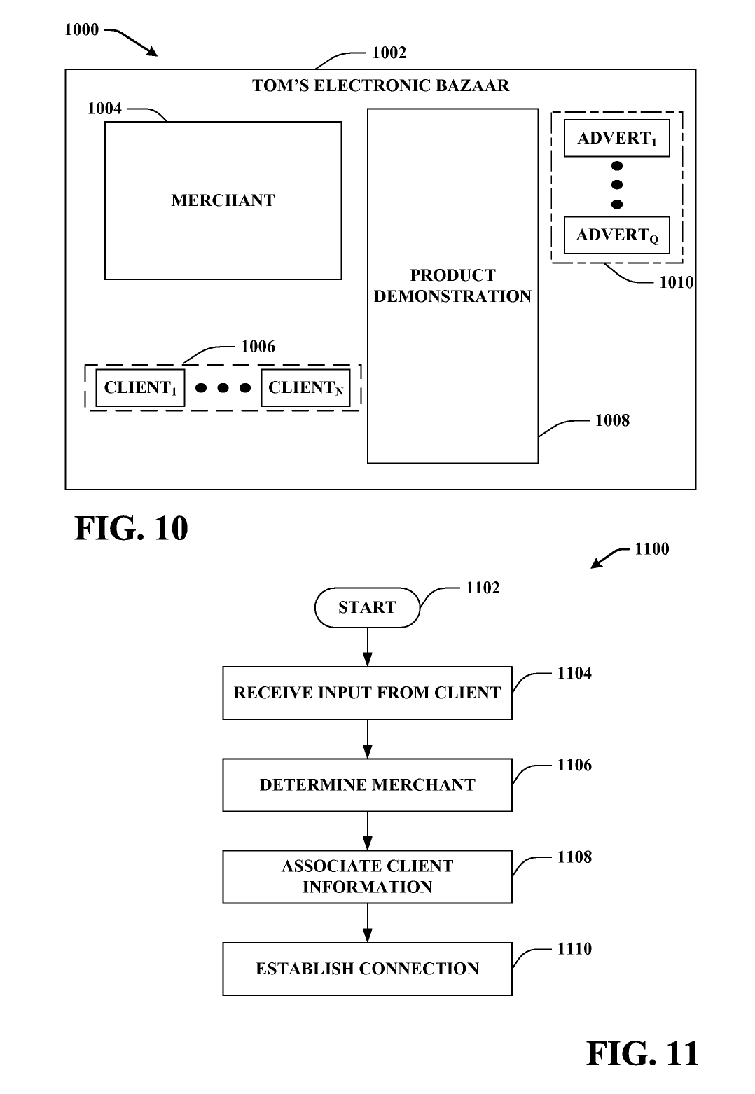

FIG. 10 provides depiction 1000 of a session between a merchant and consumers in accordance with another aspect of the claimed subject matter. FIG. 10 illustrates an illustrative display page 1002 that can simultaneously be displayed on merchant device 106 and consumer device 102. Display page 1002 entitled “Tom's Electronic Bazaar” includes a window 1004 that can display a static image of the merchant. Display page 1002 can also provide one or more images of client₁ to client_{N} 1006 where N is a positive integer. Client₁ to client_{N} 1006 can be one or more individuals and/or potential customers who have accessed display page 1002 to watch the proprietor provide a product demonstration of a particular electronic component (e.g., a stereo amplifier, HDTV, building a gaming PC, etc.). A product demonstration window 1008 can be provided wherein streaming live audio visual presentation can be displayed in window 1008. Further, display page 1002 can also include space to display advert₁ to advert_{Q} 1010 that can display one or more advertisements associated, for example, with products associated with Tom's Electronic Bazaar.

In view of the exemplary systems shown and described supra, methodologies that may be implemented in accordance with the disclosed subject matter will be better appreciated with reference to the flow chart of FIG. 11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 11 provides an illustrative flow diagram illustrating a method 1100 that facilitates and effectuates an online social shopping network in accordance with an aspect of the claimed subject matter. The method commences at 1102 where various and sundry initializations can take place after which the method can proceed to 1104. At 1104 the method can receive input in the form of data from one or more client device requesting that a particular online retail establishment provide information regarding products of interest to a user. At 1106 based at least in part on the information received from the one or more client device a determination is made to ascertain a potential merchant that might carry the items that are of interest to the user. At 1108 client information, such as, for example, rating information, age, previous transaction data, geographic location information, and the like, can be associated with a request to the potential merchant. Such associated client information can be used by the potential merchant to determine the customer's various likes and dislike, purchasing habits, etc. At 1110 an online interactive social shopping trading place is established wherein the customer and merchant can interact with one another via video, audio, static image and/or text, for example.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

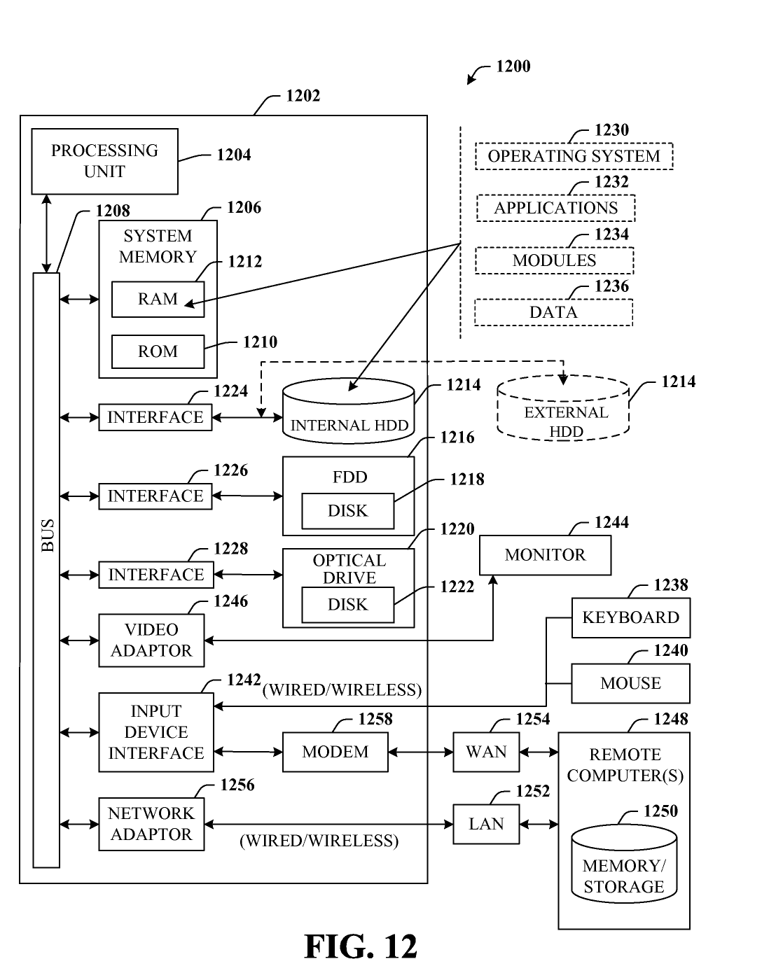

Referring now to FIG. 12, there is illustrated a block diagram of a computer operable to execute the disclosed system. In order to provide additional context for various aspects thereof, FIG. 12 and the following discussion are intended to provide a brief, general description of a suitable computing environment 1200 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the claimed subject matter can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

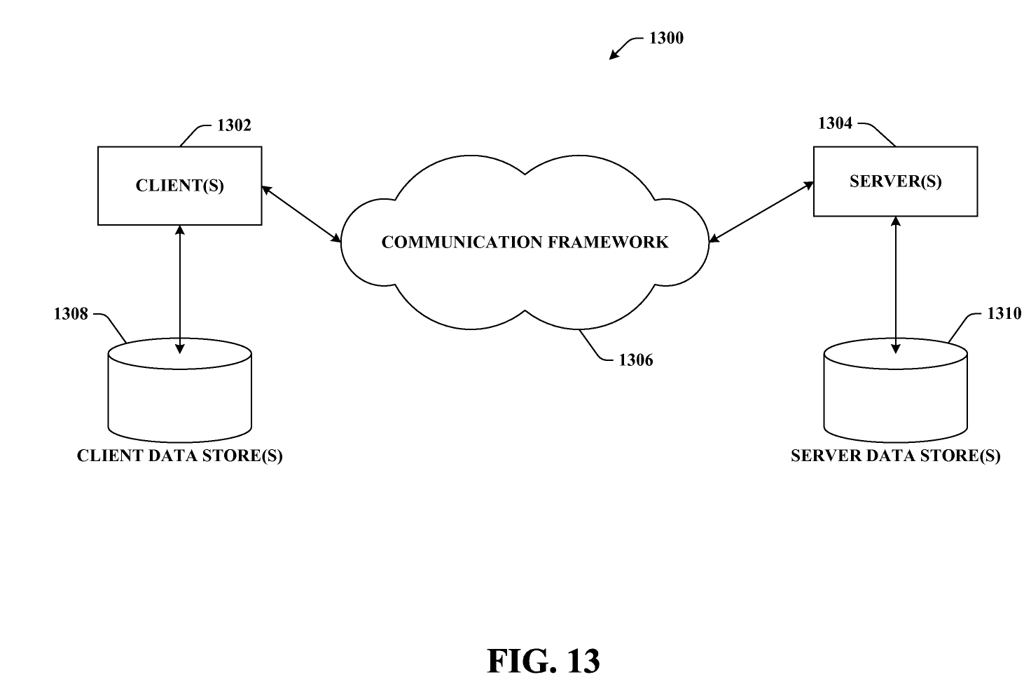

Referring now to FIG. 13, there is illustrated a schematic block diagram of an exemplary computing environment 1300 for processing the interactive online social shopping architecture in accordance with another aspect. The system 1300 includes one or more client(s) 1302. The client(s) 1302 can be hardware and/or software (e.g., threads, processes, computing devices). The client(s) 1302 can house cookie(s) and/or associated contextual information by employing the claimed subject matter, for example.

The system 1300 also includes one or more server(s) 1304. The server(s) 1304 can also be hardware and/or software (e.g., threads, processes, computing devices). The servers 1304 can house threads to perform transformations by employing the claimed subject matter, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that constructs a real time interactive online social shopping network, comprising:
a portal component that receives and transmits data from a client component and a merchant component, the portal component employs the received and transmitted data to persist and associate information related to a user of the client component for display on the merchant device and utilizes the received and transmitted data to persist and associate information related to a retailer utilizing the merchant device for display on the client device.

2. The system of claim 1, the portal component utilizes one of cryptographic analysis, biometric indicators, or access control lists to control access to the real time interactive online social shopping network.

3. The system of claim 1, the portal component employs a geographical location marker to match the user of the client component with the retailer utilizing the merchant device.

4. The system of claim 3, the geographical marker relates to one of a country, county, state, province, city, town, zip code, or postal code.

5. The system of claim 1, further includes a rating component that generates and associates a rating to the user of the client component.

6. The system of claim 5, the rating component generates and associates a rating to the retailer associated with the merchant component.

7. The system of claim 5, the rating component employs persisted information associated with the user of the client component to generate data related to a number of transactions that have taken place between the user and the retailer.

8. The system of claim 5, the rating component utilizes persisted information or information gathered in real-time from the user of the client component to restrict access to the merchant component by the user of the client component.

9. The system of claim 1, the portal component periodically and automatically searches one or more disparate network topology to locate and aggregate other portal components to form a global real time interactive online social shopping network.

10. The system of claim 9, the portal component fractionates the global real time interactive online social shopping network based at least in part on geographical location.

11. The system of claim 9, the portal component groups merchants included in the global real time interactive online social shopping network based at least in part on a common product.

12. The system of claim 1, the merchant component includes a video capture facility or a video display.

13. The system of claim 1, the merchant component, the client component, or the portal component situated in one or more diverse geographical locations.

14. The system of claim 1, the merchant component or the client component is a cell phone, a Smart phone, or a handheld portable device.

15. The system of claim 1, the retailer associated with the merchant device utilize a dynamic video capture facility associated with the merchant device to broadcast a real-time product demonstration to the client component for immediate viewing by the user of the client component.

16. The system of claim 1, the retailer utilizes the merchant device and the user employs the client device to establish and communicate through a real time text communication.

17. A machine implemented method for establishing a realtime interactive online social shopping network, comprising:
receiving and transmitting data from a first component to a second component;
employing received and transmitted data to persist and associate information related to a user of the first component for display on the second component; and
utilizing the received and transmitted data to persist and associate information related to a retailer utilizing the second component for display on the first component.

18. The method of claim 17, further includes restricting access to the retailer by the user based at least in part on information related to the user of the first component.

19. The method of claim 17, further includes displaying on the first component streaming video generated by the second component of the retailer performing a product demonstration.

20. A system that constructs a real time interactive online social shopping network, comprising
means for receiving and transmitting data from a first component to a second component;
means for persisting and associating information related to a user of the first component;
mean for displaying information related to a user on the second component; and
means for displaying streaming video generated by a retailer utilizing the second component.
